(19) United States
(12) Patent Application Publication
(10) Pub. No.: US 2026/0013438 A1
(43) Pub. Date: Jan. 15, 2026

(54) SYSTEMS AND METHODS FOR CONTROLLING AGRICULTURAL WORK MACHINE SENSITIVITY

(71) Applicant: Deere & Company, Moline, IL (US)

(72) Inventors: Nathan R. VANDIKE, Geneseo, IL (US); Martin F. UNTERPAINTNER, Saarbrücken (DE); Benjamin PESCHEL, Contwig (DE)

(21) Appl. No.: 19/231,050

(22) Filed: Jun. 6, 2025

Related U.S. Application Data
(60) Provisional application No. 63/670,419, filed on Jul. 12, 2024.

(51) Int. Cl. A01D 41/127; A01D 41/14

(52) U.S. Cl. CPC A01D 41/1277; A01D 41/141

(57) ABSTRACT

An agricultural system includes one or more processors and memory storing instructions executable by the one or more processors. The instructions, when executed by the one or more processors, configure the agricultural system to: monitor a performance parameter of an agricultural work machine at a worksite; monitor one or more operational environment conditions relative to the worksite; determine a sensitivity with which to control the agricultural work machine based, at least, on the one or more operational environment conditions; and control the agricultural work machine based, at least, on the sensitivity.

### CROSS-REFERENCE TO RELATED APPLICATION

The present application is based on and claims the benefit of U.S. Provisional Patent Application Ser. No. 63/670,419 filed, Jul. 12, 2024, the content of which is hereby incorporated by reference in its entirety.

### FIELD OF THE DESCRIPTION

The present description relates to agricultural work machine operations. More specifically, the present description relates to agricultural work machine operations, monitoring agricultural work machine performance parameters and operating conditions, and controlling agricultural work machine control sensitivity.

### BACKGROUND

There are a wide variety of different types of agricultural work machines. One such example agricultural work machine is an agricultural harvester (or harvester) that is used to harvest various crops, such as different types of grain crops. While harvesting crop, the harvesters may also generate residue, which can be made up of all or some of the non-harvested portions of the target crop. Some harvesters include residue monitoring systems to monitor crop residue generated by the harvester, which may be used to adjust future field harvesting operations based upon an analysis of the collected information. However, monitoring and controlling residue system performance can be challenging due to environmental conditions, a location of residue spread relative to an operator location, and the changing in-situ conditions. In some cases, active residue monitoring systems may over-react to situations, or can create overcompensation issues that result in additional adverse harvest conditions and field quality.

The discussion above is merely provided for general background information and is not intended to be used as an aid in determining the scope of the claimed subject matter.

### SUMMARY

An agricultural system includes one or more processors and memory storing instructions executable by the one or more processors. The instructions, when executed by the one or more processors, configure the agricultural system to: monitor a performance parameter of an agricultural work machine at a worksite; monitor one or more operational environment conditions relative to the worksite; determine a sensitivity with which to control the agricultural work machine based, at least, on the one or more operational environment conditions; and control the agricultural work machine based, at least, on the sensitivity.

One or more techniques and/or systems are disclosed for adjusting a level of sensitivity of a residue distribution system. Sensors are used to detect real time conditions for a harvester that is harvesting a crop, and adjustments can be made to the residue disbursement system on the fly to meet a desired distribution profile. Data indicative of the real time conditions can be collected and monitored to detect changes in the conditions over time. The changes over time can be indicative of a level of change in conditions, indicative of variability in the conditions, and a level of sensitivity for making adjustments to the residue system can be adjusted based on the level of variability. In this way, the system can change the level of sensitivity to reduce over adjustments or quick adjustments, and a more even set of adjustments and changes to the residue distribution can be made to accommodate the distribution profile.

In one implementation, a crop residue adjustment system for a crop harvester can comprise a sensor array that may be configured to provide input data indicative of one or more conditions that affect residue distribution from a harvester that is harvesting a target crop in real time. A control unit can be used to receive the input data. The control unit can comprise a processor for processing instructions and data. The control unit can further comprise memory that stores instructions and a residue distribution profile. When the instruction are executed by the processor, the instructions can be configured to identify a level of variation between the one or more conditions that affect residue distribution over time. The instructions can be further configured to compare the identified level of variation with a predetermined threshold in the residue distribution profile. The instructions can also be configured to adjust a level of sensitivity for changes to one or more components of the harvester that affect the residue distribution from the harvester. In this implementation, the changes to the one or more components of the harvester that affect the residue distribution from the harvester comprise data indicative of an action command that adjusts an action of the one or more components of the harvester. Further, the level of sensitivity is indicative of a range of change over time of the one or more conditions that affect residue distribution.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a component diagram illustrating a perspective view of a harvester according to an implementation of one or more portions of one or more systems described herein.

FIG. 2 is a component diagram illustrating a perspective view of a residue system according to an implementation of one or more portions of one or more systems described herein.

FIG. 3 is a schematic diagram illustrating one example implementation of a system for adjusting a sensitivity level of an agricultural work machine.

FIG. 4 is a component diagram illustrating a perspective view of a harvester according to an implementation of one or more portions of one or more systems described herein.

FIG. 5 is a schematic diagram illustrating another example implementation of a system for adjusting a sensitivity level of an agricultural work machine.

FIG. 6 is a flow diagram illustrating an example method for adjusting a level of sensitivity of an agricultural work machine.

FIG. 7 is a flow diagram illustrating another example method for adjusting a level of sensitivity of an agricultural work machine.

FIG. 8 is a block diagram of one example of a system for adjusting a sensitivity level of an agricultural work machine.

FIG. 9 is a schematic block diagram illustrating an exemplary computing system that may be used by one or more portions of one of more systems described herein.

FIG. 10 is a block diagram showing one example of items of the system in communication with a remote server architecture.

FIGS. 11, 12, and 13 show examples of mobile devices that can be used in the system herein.

FIG. 14 is a block diagram showing one example of a computing environment that can be used in the system herein.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example can be combined with the features, components, and/or steps described with respect to other examples of the present disclosure.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Traditional control systems for agricultural work machines (e.g., harvesters) and agricultural work machine operations (e.g., harvesting operations) monitor performance by monitoring sensor signals of a characteristic of interest (e.g. performance). Generally there will be a target performance level that is desired for the operation, and if the sensor signals indicate that performance is not within some threshold of the target, a control system will identify an adjustment of certain operating parameters (e.g., settings) of the work machine to bring the signal response (e.g., sensed performance) back to the target level.

However, operational environments of an agricultural work machine (e.g., harvester) are not consistent, and variability in the operational environment can cause signals of the sensor to change over time, sometimes drastically, which can sometimes put control systems into an unstable state of making multiple adjustments to try to keep up with the constant changes. For example, a sensor signal may be lower than its target level, and as the control system makes adjustments to the operational parameters (e.g., settings) to bring the sensor signal back toward its target, variability in the operational environment might cause the sensor signal to change rapidly such that it is above the target level. In this example, if the system is in process (e.g., processing data and instructions for incoming signals) or has recently made an adjustment to raise the signal value, then this operational environment change coupled with the original planned change in operational parameter could cause the resulting performance to be significantly above the target, thus causing the control system to react (e.g., over-react) and attempt to bring the sensor signal back down. If the operational environment keeps changing, causing the sensor signals' levels to change frequently between below and above targets, the system may become unstable due to the constant, ongoing reactions, thereby reducing overall performance, and potentially causing more issues than it is solving, for example.

In order to overcome some of these issues, a system can be devised that is used to identify how the operational environment (e.g., and changes in said operational environment) might impact the performance of the operation. Using this information, the system can set a control system sensitivity to a level that allows the control system to perform in a relatively stable manner, while keeping operational performance near a target level without causing more issues. Further, the system can maintain the ability to react to changes, where adjustments need to be made when variability in the operational environment is low, thus allowing more aggressive changes when the environment is relatively stable, for example.

The methods and systems disclosed herein, for example, may be suitable for use in different harvester applications that also distribute residue back to the field during harvesting. That is, the herein disclosed examples can be implemented in different harvesting equipment, for different types of harvested crops. In these implementations, the control of adjustment sensitivity to a residue system in the harvester is provided.

A system may be devised to improve operational performance of an agricultural work machine (e.g., harvester) or a system thereof (e.g., a residue system), by compensating for operational environment variability during an operation (e.g., harvesting). Example systems described herein can implement a monitoring system, comprising one or more sensors and a data processing component that: determines the ranges and variability of the contributing factors (e.g., operational environment) to agricultural work machine performance (e.g., residue performance, such as residue spread quality, residue chopping quality, etc.). For example, the monitoring system monitors, as contributing factors to performance of a harvester, the feedrate and feedrate changes that are coming into the machine, where feedrate can be observed from actual feedrate systems, changes in machine travel speed, changes in header height or material flow properties of the header, crop moisture, by monitoring the plant moisture or plant moisture changes of product that is entering the machine; and the wind conditions. Further, for example, a control system can be coupled with the monitoring system to set the agricultural work machine control system sensitivity (e.g., threshold parameters) based on the information generated from the monitoring, including various ranges and variability factors.

For example, if the ranges of the input factors are at a selected threshold target value (e.g., above or below), all or a portion of the operating parameters can be set to high or low limits. Additionally, in this example, if operational environment variability is determined to be at a selected level (e.g., above), then control system sensitivity can be modified (e.g., reduced) so that the control system is not overly responsive and creating additional issues, for example. The limits/targets of the system can also be modified (e.g., reduced) so that performance is limited to avoid poor performance (e.g., residue overthrow/overspread). Conversely, in this example, if variability is determined to be at a selected level (e.g., below), then control system sensitivity can be modified (e.g., increased) so that the control system is more responsive to detected changes. The limits/targets of the system can also be modified (e.g., increased) so that the maximum performance is closer to a desired state for the operation, because risk of poor performance (e.g., residue overthrow/overspread) would be reduced. For example, the input variables can be selected from sensed values (e.g., during monitoring) or may be provided from predetermined values associated with or pre-input from a map connected with the system, predicted values, and/or provided as part of a connected application, such as a weather application.

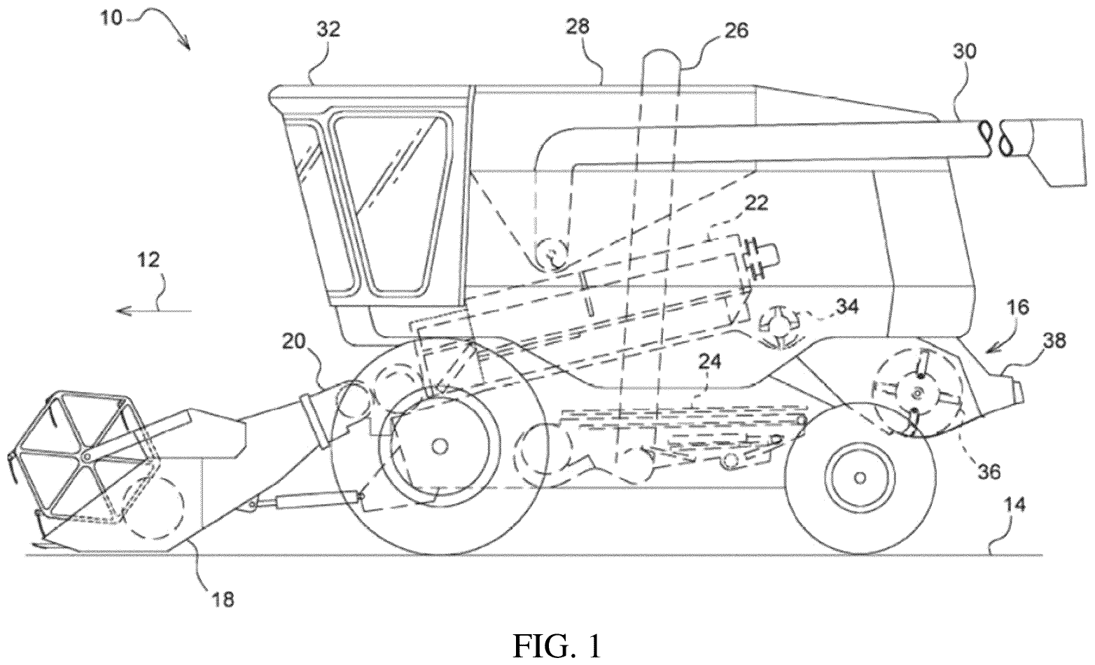

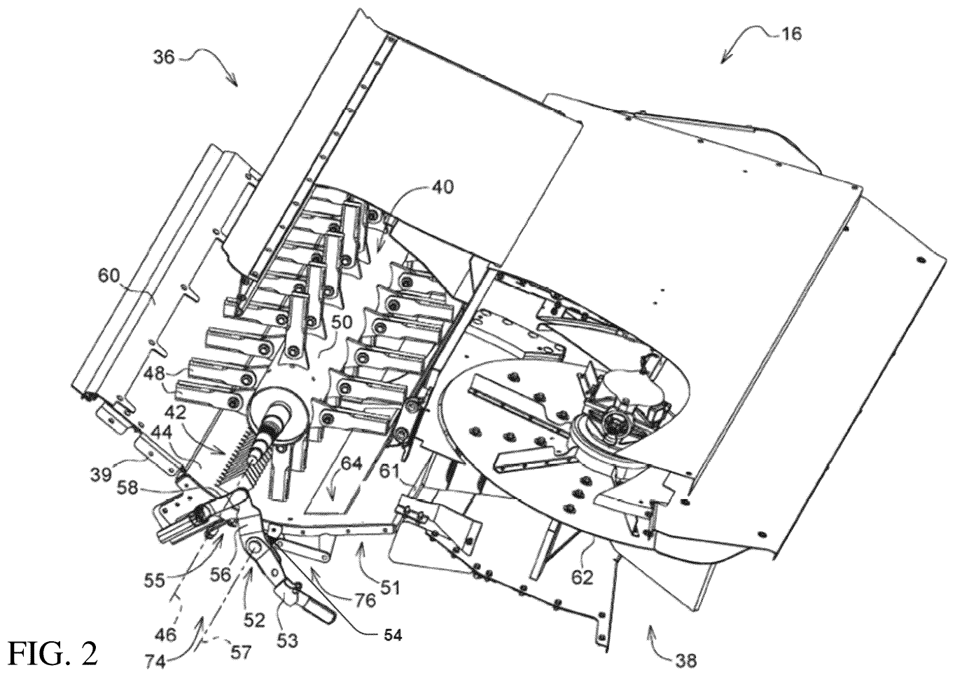

FIG. 1 is a component diagram illustrating one example agricultural work machine where one or more of the systems and methods described herein may be implemented. FIG. 2 is a component diagram illustrating one example agricultural work machine system where one or more of the systems and methods described herein may be implemented. FIG. 1 illustrates one example of an agricultural harvester 10, which is configured to move in a forward direction of travel 12 over a field 14 to harvest crop from the field 14. The harvester 10 processes the crop, separating grain from crop residue (e.g., straw, stalks, cobs, leaves, chaff). The harvester 10 includes a residue management system (or residue system) 16 for returning crop residue, derived from harvested crop, back to the field 14.

In general, the harvester 10 can include an implement 18 to cut, gather, and transport crop rearwardly, a feederhouse 20 to advance crop received from the implement into the body of the harvester 10, a threshing and separating section 22 to thresh crop and further separate grain from crop residue, a cleaning section 24 including one more chaffers and sieves to separate grain from chaff or other relatively small pieces of crop material, a clean grain elevator 26 to elevate clean grain to a storage bin 28, an unloader 30 to unload clean grain from the storage bin 28 to another location, and a beater 34 to beat residue that is received from the threshing and separating section 22 and does not pass to the cleaning section 24 (e.g., straw, stalks, cobs, leaves). A person can control the harvester 10 from an operator's station 32 of the harvester 10. The harvester 10, including such portions thereof, can be configured in a wide variety of ways.

FIG. 2 illustrates one example of a residue management system (or residue system) 16, which includes a chopper 36 and a residue spreader 38. The chopper 36 chops crop residue derived from the crop harvested from the field 14 by the harvester 10. The residue spreader 38 is positioned rearward of the chopper 36. In some examples, the residue spreader 38 can be mounted for pivotable movement relative to the chopper 36 between a dispersal position to disperse crop residue received from the chopper 36 onto the field 14 and a windrow position to deposit crop residue received over the residue spreader from the harvester onto the field 14 in a windrow. In other examples, the residue spreader 38 can be mounted in a fixed position relative to the chopper 36.

The chopper 36 can receive crop residue from the threshing and separating section 22 and the cleaning section 24. In some examples, the harvester 10 includes a door that is closed to direct crop residue from the threshing and separating section 22 and the beater 34 to the chopper for chopping when the residue spreader 38 is positioned in the dispersal position. When the residue spreader 38 is positioned in the windrow position, the door is closed to direct crop residue from the threshing and separating section 22 and the beater 34 over the top of the residue spreader 38 to deposit crop residue onto the field 14 in a windrow. In some examples, the chopper 36 can receive crop residue in the form of, for example, chaff from the cleaning section 24 in one or both of the dispersal position and the windrow position.

In this example implementation, the chopper 36 includes a housing 39, a rotor 40, and a bank of counter-knives 42. The rotor 40 is mounted to the housing 39 and positioned in an interior region 44 of the housing 39 for rotation therein about an axis of rotation 46 relative to the housing 39. The rotor 40 includes blades 48 that interact with the bank of counter-knives 42 to chop crop residue upon rotation of the rotor 40 about the axis of rotation 46 in a chopping direction 49. The blades 48 are mounted about the periphery of a hub 50 of the rotor 40. In this example, the rotor is a flail rotor, such that the blades 48 are flail blades; although other implementations are anticipated.

The bank of counter-knives 42 is movable relative to the rotor 40 to adjust a chopping aggressiveness of the chopper 36. The bank of counter-knives 42 is movable relative to the rotor 40 and the axis of rotation 46 between at least two or more operational positions (e.g., to adjust chopping aggressiveness), defining engagement positions. As illustrated, the counter-knives 42 can extend through corresponding slits in an outlet floor 51 of the housing 39 to extend alternatingly between the blades 48 to promote chopping of crop residue that enters the interior region 44. Greater extension from the outlet floor 51 into the interior region 44 corresponding to more engagement and thus more chopping. The bank of counter-knives 42 move in a linear manner toward and away from the rotor 40 and its axis of rotation 46 between engagement positions. In other examples, the bank of counter-knives 42 could be configured to move in other between engagement positions ways (e.g., pivotally).

The chopper 36 includes a knife actuator 52 to adjust the engagement position of the bank of counter-knives 42. The knife actuator 52 is operable to move the bank of counter-knives 42 between the various operational positions. In this example, the knife actuator 52 is manually operable to move the bank of counter-knives 42 between operational positions. However, it is anticipated that a remotely operated actuator can be used to move the bank of counter-knives between the various operational positions. In this example, the knife actuator 52 includes a handle 53, a rotatable shaft 54, and a linkage 55. The shaft 54 rotates therewith about an axis of rotation 57 of the shaft 54. The linkage 55 includes a second link 58 pivotally coupled to the first link 56, and the component is coupled to the bank of counter-knives 42. The knife actuator 52 also includes another linkage 55 and sliding element 59 similarly configured and arranged at the opposite end of the bank of counter-knives 42. To change the operational position of the bank of counter-knives 42, an operator can move the handle 53 causing the shaft 54 to rotate about the axis 57 and the linkages 55, in the corresponding slots, to move the bank of counter-knives 42 linearly between aggressiveness positions.

The housing 39 includes a residue inlet 60 and a residue outlet 61. Crop residue from the threshing and separating section 22 and beater 34 can enter the chopper 36 through the residue inlet 60 into interior region 44. Crop residue can exit the chopper 36 from the interior region 44 through the residue outlet 61 to the residue spreader 38.

In some examples, the residue spreader 38 includes a right spreading device 62 and a left spreading device (not shown, similar to 62) laterally adjacent to the right spreading device 62 (only right spreading device 62 shown). Each spreading device 62 is configured to disperse crop residue onto the field 14 when the residue spreader 38 is positioned in the dispersal position. The spreading device 62 can be configured and operated in a wide variety of ways. For example, illustratively, the spreading device 62 includes an impeller with a rotating disk and paddles depending therefrom for dispersing crop residue from the residue spreader 38.

The operational position of the bank of counter-knives 42 can affect the trajectory of crop residue through the residue outlet 61 relative to the residue spreader 38. The chopper 36 tends to direct crop residue more at the residue spreader 38 and its spreading devices 62 with increased chopping aggressiveness of the bank of counter-knives 42 (e.g., increased engagement). The outlet floor 51 of the chopper 36 can have a variable geometry to manage the trajectory of crop residue relative to the residue spreader 38. In some implementations, the outlet floor 51 can include one or more ramps 64. The ramps 64 can be longitudinally aligned relative to one another, so as to collectively span a width of the interior region 44.

For example, each ramp 64 can be positioned downstream from the bank of counter-knives 42 relative to the chopping direction 49. The ramp 64 is movable relative to the rotor 40 and the axis of rotation 46 between a number of ramp positions to manage the trajectory of crop residue relative to the residue spreader 38. The chopper 36 includes an adjuster 74. The adjuster 74 is coupled with the bank of counter-knives 42 and the ramp 64 to position the ramp 64 in correspondence with the operational position of the bank of counter-knives 42. The adjuster 74 positions the ramp 64 in the various ramp positions. The adjuster 74 comprises the knife actuator 52 and a ramp actuator 76.

It should be noted that these illustrations and descriptions are used to illustrate the operations of the harvester vehicle and residue system, which can be used in conjunction with the systems and methods described herein. While the examples provided illustrate merely one type of harvester and residue system, it is anticipated that other types of harvesters and residue systems may be utilized with the innovative concepts described herein. The methods and systems disclosed herein, for example, may be suitable for use in different harvesters and harvesting applications. That is, disclosed examples can be implemented in different harvesters and residue systems to analyze parameters that affect residue performance, which can result in improved performance to determine when operational changes are needed. For example, one or more described examples may allow for improved analysis of conditions (e.g., crop quality, weather, crop conditions, etc.) that affect residue performance (e.g., residue performance) and analysis of the residue performance to more effectively inform a control system for appropriate adjustment for a residue system. As such, improved real-time residue system adjustments can be made.

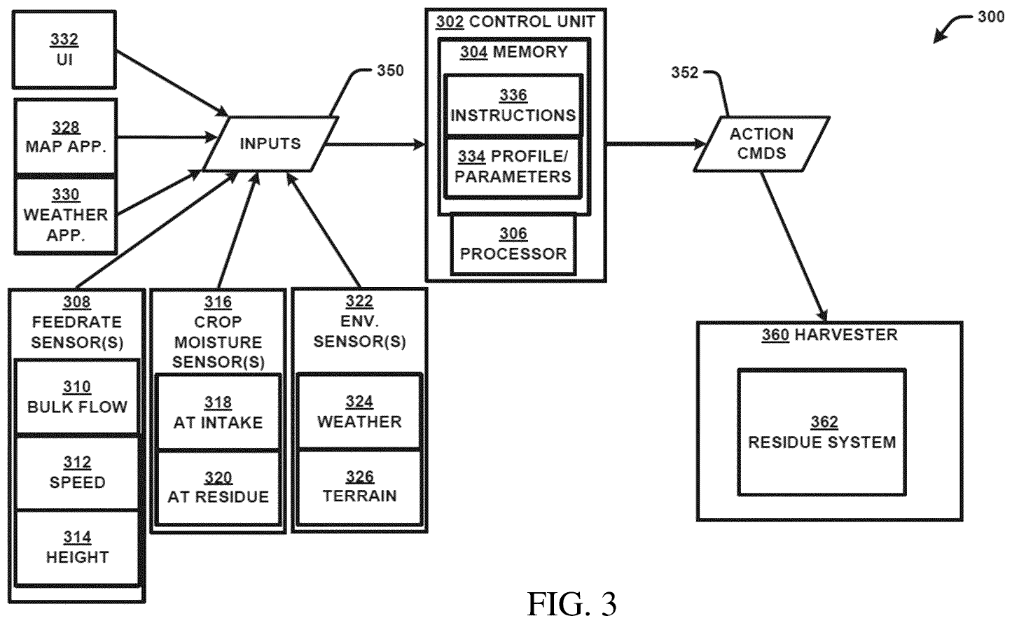

FIG. 3 is a schematic diagram that illustrates one implementation of an example system 300 for adjusting crop residue distribution in real-time. The example system 300 can comprise a control unit 302 (e.g., comprising memory 304 and a processor 306) that receives data indicative of inputs 350 and provides data indicative of action commands 352 to equipment/components in the harvester and/or residue system (e.g., 10 and 16 of FIGS. 1 and 2) to make adjustments to the operating parameters of the harvester and/or residue system, based at least on the inputs 350. It should be noted that, while the illustration indicates a single control unit for the purpose of clarity of description, the control unit may be comprised of distributed components. For example, a portion of the control unit (e.g., a first portion) can be disposed at a central processing location, such as in the main computing center of the harvesting machine, in the operator cab, engine compartment, etc., while another portion of the control unit (e.g., a second portion) can be disposed in/on or proximate the harvesting components of the harvester, such as at the residue system. In this way, some input data 350 may be received at the second portion, while other input data 350 may be received at the first portion, for example. As another example, a first portion of the control unit can comprise a monitoring system that monitors real-time input data that is indicative of conditions that may affect the performance of residue system, and a second portion can comprise a control system that controls/adjusts the residue system based on information provided by the monitoring system and a desired result (e.g., desired performance).

In some implementations, input data 350 can comprise variables such as crop feedrate, crop moisture content, environmental conditions, such as wind and terrain. In these implementations, feedrate can be affected by the bulk flow of the crop entering the header, the machine travel speed, and height of the header relative to the ground. As an example, these conditions can be monitored by one or more feedrate sensors 308, such as a bulk flow sensor 310 (e.g., imaging device) disposed on the harvester to look-forward, such as at the harvester's header intake or at another location (e.g., location on the field, etc.), a speed sensor 312 for the work machine, and a height sensor 314 or gauge disposed at the header. Data generated by these one or more sensors can be part of the input data 350 received by (e.g., sent to, or polled from the sensors by) the control unit 302.

Further, the crop moisture data can be derived from the moisture level of the crop entering the header, and/or the residue moisture level of the residue at the residue system. That is, for example, crop moisture data may comprise merely the level of moisture sensed as the crop travels through the machine (e.g., as the crop enters the header, other locations within the machine, such as in the feederhouse, etc.), as the residue exits the header, or a combination where a moisture level difference is identified between the intake of the crop and disbursement of the residue. In this implementation, the crop moisture sensor(s) 316 (e.g., moisture meters) can comprise an intake moisture sensor 318 at the header, and residue moisture sensor 320 at the residue system.

Additionally, environmental data, such as weather and terrain conditions, can be generated using one or more environmental sensors 322. Environmental sensors 322 can comprise weather sensors 324 (e.g., wind gauge, rain gauge, humidity sensor, moisture detector, etc.) that detect environmental conditions that may affect performance (e.g., residue performance). One or more terrain sensors 326 can also be utilized to detect terrain conditions, such as pitch and roll sensors of the harvester, moisture conditions of the soil, etc. The data generated by the respective sensors 322 can be part of the input data 350 to the control unit 302.

In some implementations, the example system 300 can comprise a mapping application 328 and/or a weather application 330. These applications may be resident in memory (e.g., such as the memory 304 of the control unit 302) in the system 300 or may be operating on a separate computing device communicatively coupled with the system 300. For example, the mapping application 328 can comprise pre-programmed maps of the target crop area, with pre-identified terrain conditions of the operational area (e.g., satellite imagery, elevations, soil conditions, etc.). Further, the weather application 330 can provide real time and predicted weather conditions for the operational area. The data generated/provided by these applications 328, 330 can be part of the input data 350 to the control unit 302.

In some implementations, the data inputs 350 can comprise or be indicative of information provided by an operator using a user interface 332 (UI) which the operator can use to input data, instructions, updates, programming, etc. As an example, the operator can use the UI 332 to input operational parameters (e.g., settings) for the harvester, such as a desired operational parameter for the residue system, and can use the UI 332 to update data that may affect performance (e.g., residue performance), such as, type of crop, and other data that may affect performance (e.g., residue performance).

The control unit 302 can receive the input data 350 and use it to generate the action commands 352, such as to meet the desired performance (e.g., desired residue performance), based on the operation of the harvester 360, or system thereof, such as residue system (e.g., 16 of FIGS. 1 and 2). That is, for example, the memory 304 can comprise instructions/programming 336 that identifies conditions that may affect the performance (e.g., residue performance), which may also be based on the current operational parameters of the harvester, or system thereof (e.g., residue system), and the input data 350. Further, the instructions/programming 336 can be used to determine changes or adjustments to the operational parameters (e.g., changes to operational parameters of the residue system) to meet stored desired parameters (e.g., ranges in the profile 334 stored in memory 304) for the of the performance (e.g., residue performance). For example, the operator (e.g., or a pre-programmed operational guidance system) may set a desired type of residue distribution, such as placing the residue in a particular location, at a particular density, while mitigating overthrow or overlapping residue. That is, typically, the operator may desire to have an even distribution of the residue across the harvested field, with little overlap.

In some implementations, the ranges of performance (e.g., profile 334) can be preset by a harvesting operations program, or may be set by the operator. In these implementations, the operational parameters for the harvester, or system (e.g., residue system) thereof, can be set based on the preset profile 334 for the performance. That is, for example, the speed or intensity or aggressiveness of the chopping (as described above) can be set for the residue system, along with the harvester speed, and the header height, all based on the input desired performance (e.g., residue performance) indicated by the profile. In this way, at the initiation of operation, the harvester and systems thereof (e.g., residue system) can operate under parameters in the profile 334 to meet the desired performance of the profile. Further, the profile can include preset ranges for each of the input data 350 (e.g., feedrates 308, crop moisture 316, and environmental 322) that are expected to meet (e.g., enable) the desired performance of the profile 334 during operation.

During operation, the control unit 302 can monitor the input data (e.g., or a monitoring portion of the control unit 302) to identify if the data inputs 350 are within the ranges to meet the profile 334. As an example, if the input data 350 identifies that performance (e.g., residue performance) is within the ranges of the profile 334, the operation of the harvester can maintain operational parameters. When the input data 350 indicates that the performance (e.g., residue performance) are outside the ranges of the profile, the control unit can generate commands 352 that adjust one or more portions of the harvester 360 operational parameters to bring the performance within the desired ranges.

As another example, when the input data 350 indicates a high degree of variability within the input data 350, the control unit may adjust sensitivity of the adjustments. That is, the operational parameters of the harvester 360 and residue systems 362 can be adjusted to meet the preferred profile 334 (e.g., desired performance), but it may be undesirable to adjust the operational parameters too quickly or to over-adjust, which may lead to undesired results. As such, if predetermined threshold target value of variability is met, then the control unit 302 can use the instruction 336 to adjust a response sensitivity of the system (e.g., reduced) so that the system is not overly responsive. Additionally, based on the input data 350, performance of the system can be improved by adjusting maximum operational parameter limits on the fly, to avoid adverse conditions (e.g., residue overthrow). Alternately, if the variability level is determined to be low (e.g., little change in conditions provided by the input data 350) then response sensitivity of the system can be modified (e.g., increased) so that the system is more responsive to detected changes. Thus, the sensitivity can be changed dynamically during the operation based on input data 350, such as increasing or decreasing sensitivity based on variability of conditions or variables indicated by input data 350. Additionally, the operational parameter limits can also be adjusted on the fly based on input data 350.

It will be understood that instructions 336 can instruct control unit 302 to determine a variability of the input data (e.g., operational environment conditions) based on analysis of the input data (e.g., operational environment conditions), such as various statistical analyses (e.g., standard deviations, a number of changes over a course of time, a range of the values, the number of changes or the range of values relative to a on expected levels (values, value ranges, variability level, etc.) of the input data (e.g., operational environment conditions). Expected values, value ranges, variability levels, etc. of the input data (e.g., operational environment conditions) can be detailed in profile 334 and used for reference, by control unit 302, in the analysis of variability of the input data (e.g., operational environment conditions).

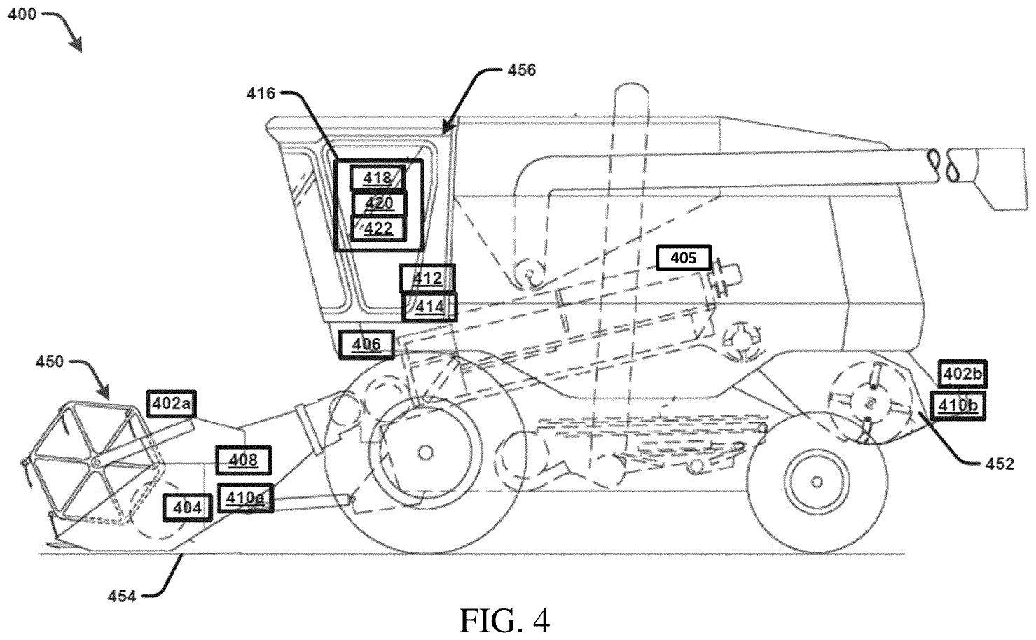

FIG. 4 is a component diagram illustrating one example implementation of a harvester system (or harvester) 400 as implemented herein. In one or more examples, an imaging component 402a (e.g., camera) captures images of the crop intake at the header 450, a pressure sensor 404 is disposed in the header to detect a bulk flow rate through the header 450, and/or a pressure sensor 405 is associated with the threshing system to detect a bulk flow of crop through the harvester. Further, an imaging component 402b can be disposed at the residue system 452 to detect a condition of the residue generated by the harvester 400 (e.g., operation condition). In one implementation, the image sensors 402a, 402b can capture images of the crop before and after the crop has been discharged, and the spread by the harvester 400. In some implementations, multiple image sensors 402 are utilized at each location to capture images of the crop and crop residue before, during, and after collection and processing of the crop. The image data can be used as the input data 350. A pressure sensor 404 in the header 450 can detect an amount of pressure needed to collect the crop. This pressure data can be indicative of the bulk flow of the crop through the header 450, and used as the input data 350. A pressure sensor 405 associated with the threshing system can detect an amount of pressure needed to drive the threshing element and this pressure data can be indicative of a bulk flow of the crop through the harvester and used as the input data 350.

Further, as described above, a speed sensor 406 can be disposed in the harvester 400 to detect ground speed. A height sensor 408 can be used to detect a height of the header 450 above the ground 454. One or more crop moisture sensors 410a, 410b can be disposed at the header 450 and/or at the residue system 452 to detect the moisture content of the crop, and/or the difference between the crop intake moisture and residue moisture. The example locations of sensors 410a and 410b are merely some examples. In other examples, sensors 410a and 410b, or similar sensors, can be disposed at other locations and/or detect crop moisture at other locations, such as other locations internal to the machine or external to the machine. Further, a weather sensor 412 and a terrain sensor 414 can be disposed in the harvester to detect weather conditions in real time, and to detect terrain conditions. In some implementations, a computing device 416 can be disposed in the operator cab 456. In these implementations, the computing device 416 can comprise a UI 418 for user input, and may also comprise a mapping application 420 and a weather application 422. The mapping application can provide terrain data as well as other condition data as previously described, and the weather application can provide weather data.

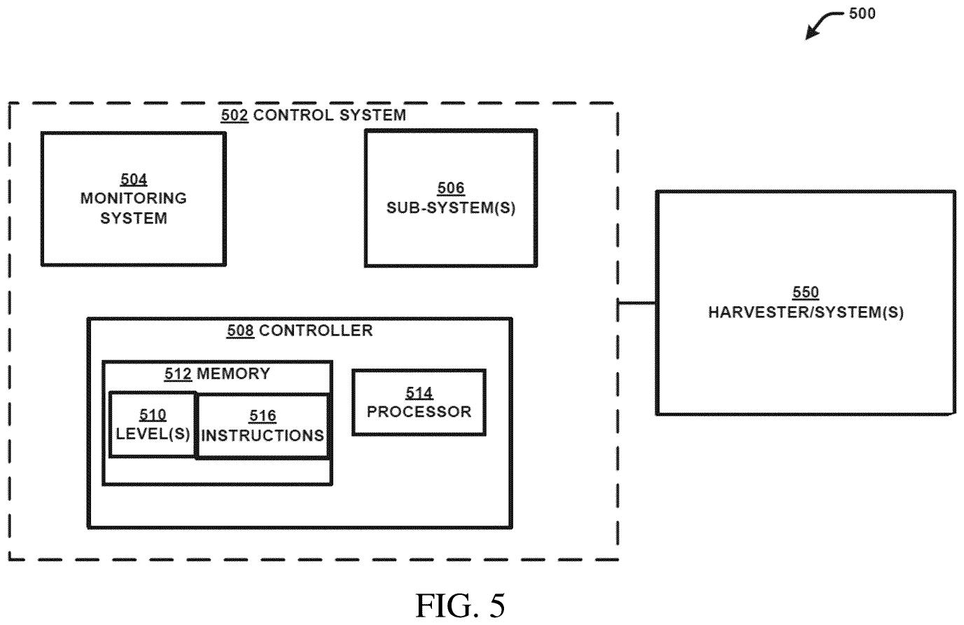

In some implementations, as illustrated in FIG. 5, a system 500 for improving performance of an agricultural work machine (e.g., harvester), during an operation, by compensating for variability of the operational environment during the operation, can comprise a control system 502. The control system can comprise a monitoring system 504 that is configured to sense a characteristic of interest, such as a performance parameter (e.g., a residue performance). Further, the control system 502 can comprise at least one sub-system 506 (e.g., environmental sensors 322, crop condition/moisture sensors 316, feedrate sensors 308, map application 328, weather application 330) that is configured to determine a characteristic of the operational environment. Additionally, a controller 508 can be configured to determine (e.g., using stored instructions 516 processed by a processor 514) if the characteristic of the operational environment is within an expected level 510 (e.g., profile 334), which can be stored in memory 512. The controller 508 can be further configured to determine sensitivity of the system (e.g., limits/thresholds of performance parameters or limits of operational parameters) based on the level of the operational environment characteristic. The controller 508 can be further configured to adjust the harvester operational parameters based on the established sensitivity and the sensed characteristic of interest (e.g., performance parameter).

In this example, the system 500 can further comprise the controller 508 adjusting the operational parameters of the harvester 550 based on the sensed characteristic of interest (e.g., performance parameter). In this example, the expected level 510 can comprise a minimum and maximum value (e.g., threshold range) of the environmental condition. Further, the expected level 510 can comprise a variability level of a detected environmental condition value. Additionally, the limits of the harvester operational parameter can comprise a minimum or maximum limit value for an operational parameter (e.g., setting) for a system of the harvester. In some implementations, the system can utilize a sensitivity value that is an indication of how sensitive or aggressive system adjustments are made to a harvester operation system (e.g., to harvester operational parameters).

It will be understood that instructions 516 can instruct control system 502 to determine a variability of the input data (e.g., operational environment conditions) based on analysis of the input data (e.g., operational environment conditions), such as various statistical analyses (e.g., standard deviations, a number of changes over a course of time, a range of the values, the number of changes or the range of values relative to a on expected levels (values, value ranges, variability level, etc.) of the input data (e.g., operational environment conditions). Expected values, value ranges, variability levels, etc. of the input data (e.g., operational environment conditions) can be detailed in levels 510 and used for reference, by control system 502, in the analysis of variability of the input data (e.g., operational environment conditions).

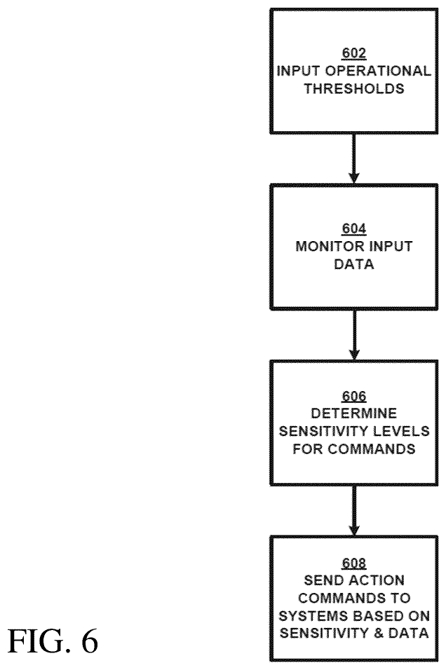

FIG. 6 is a flow diagram illustrating an example method for adjusting the sensitivity of an agricultural work machine (e.g., harvester) or a system thereof (e.g. residue system) to meet a desired performance. At 602, operational thresholds (e.g., performance parameter thresholds) are input by the operator or a pre-programmed system. The operational thresholds can be set by an input profile (e.g., 334) for the desired performance (e.g., residue performance). At 604, the various data inputs (e.g., 350) are monitored by one or more sensors (e.g., a sensor array) disposed in/on the harvester and systems thereof (e.g., residue system). The inputs, as described above, can comprise, the sensed performance parameter, bulk flow rate of intake crop, the speed of the harvester, the height of the header, the crop moisture, the weather conditions, and terrain conditions.

At 606, a control unit (e.g., 302) or control system (e.g., 502) receives the input data, and processes it in accordance with pre-programmed instructions to adjust a level of sensitivity for adjustment commands. The data can provide an indication of the conditions and variables of the operational environment, and can be used to identify the variability of the inputs (e.g., changes in conditions or variables of the operational environment over time). Based on the variability of the data, a level of adjustment sensitivity can be set. That is, if the level of change occurs rapidly over time (e.g., based on preset thresholds), the level of sensitivity can be adjusted (e.g., lowered) so that the action commands for the harvester or system (e.g., residue system) thereof are not over adjusting. Alternately, if the level of change is low over time, the level of sensitivity can be increased to account for less variability or changes to conditions or variables indicated by the data over time.

At 608, the action commands are generated and sent to the harvester and/or systems (e.g., residue system) thereof to make appropriate adjustments to the harvester and/or systems based on the level of sensitivity and the input data. In this way, the performance parameter (e.g., residue performance) can be maintained at the desired level during operation, regardless of how quickly or slowly the sensed input data changes (e.g., regardless of the variability of the conditions or variables of operational environment).

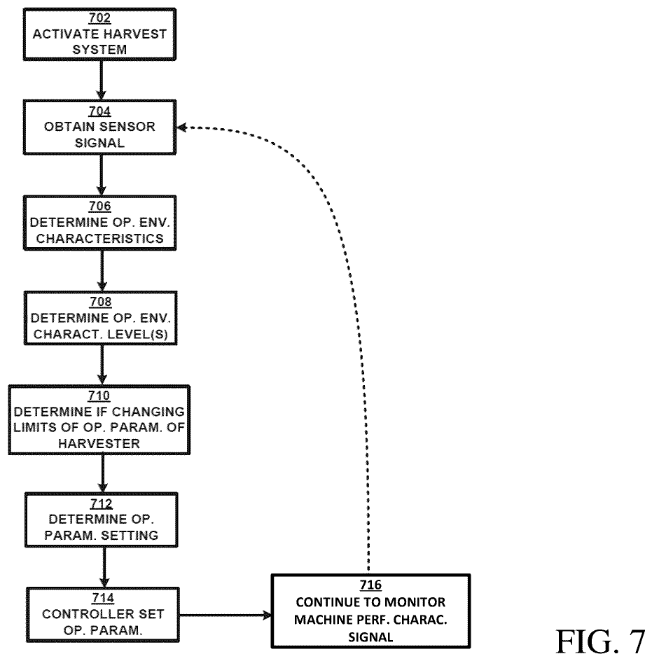

As an illustrative example, as illustrated in the flow diagram of FIG. 7, the example system (e.g., 300 of FIG. 3, 500 of FIG. 5) may utilize the example method 700. At 702 a harvest system can be activated, such as by starting the harvest process and starting the control system. At 704, a sensor signal is obtained for a characteristic of interest (e.g., performance parameter). At 706, characteristics (conditions or variables) of the operational environment can be determined. For example, the wind speed and direction can be determined; other weather conditions may be identified; the terrain type and terrain characteristics can be identified; crop characteristics, such as moisture, density, etc., can be identified; and machine operation characteristics (e.g., feedrate, travel speed, implement height, bulk flow rate, etc.) can be identified.

At 708, the set levels for the characteristics of the operational environment can be determined. For example, a minimum and maximum level (e.g., range) for each characteristic can be determined; and a variability level or range of each characteristic can be determined. At 710, it can be determined if limits (e.g., ranges) of operational parameters of the harvester/systems should be changed based on the sensed levels of the characteristics of the operational environment. As an example, the limits (e.g., ranges) of operational parameters can comprise minimum and maximum values for setting of the harvester/harvester systems; thresholds for change in the performance parameter (e.g., the performance parameter threshold) that indicate a change should be made (e.g., whether this is a threshold exceeded (above or below), a time for which the threshold is exceeded (above or below), or an amount by which the detected performance parameter must exceed (above or below) the threshold); and a change to the step size of the operational parameter adjustment. For example, if the variability of the characteristic of the operational environment is high, then the sensitivity of the control system can be reduced (e.g., by changing a threshold to be exceeded (e.g., above or below), changing a time for which the threshold value has to be exceeded (above or below), or changing an amount by which the detected performance parameter must exceed (above or below) the threshold) to not make as frequent of changes. As another example, if the variability of the characteristic of the operational environment is low, then the sensitivity of the control system can be changed (e.g., by changing a threshold to be exceeded (e.g., above or below), changing a time for which the threshold value has to be exceeded (above or below), or changing an amount by which the detected performance parameter must exceed (above or below) the threshold) to be more aggressive in responding to changes in a sensed characteristic of interest (e.g., sensed performance parameter).

At 712, in the example method 700, the operational parameter setting can be determined. In some implementations, the operational parameter setting can be determined based on the levels of the operational environment characteristic. For example, if a minimum value of a characteristic of the operational environment is above a threshold, then the operational parameter can be set to a maximum value. In some implementations, the operation parameter setting can be determined based on the levels of the operational environment characteristic and the characteristic of interest (e.g., performance parameter). In some implementations, the operational parameter setting can be determined to remain the same, even where the performance parameter is not in satisfaction with the threshold performance, due to the operational environment characteristic. For example, if the sensitivity of the control system is reduced due to high variability, even if the characteristic of interest (e.g., performance parameter) is outside a threshold target value range, the system will not respond because the value of the characteristic of interest is expected to change soon due to the high variability.

At 714, in the example method 700, the controller can set an operational parameter (e.g., setting) based on the determined operational parameter setting. In some cases there may be no change, in other cases there may be an adjustment. At 716, the system can continue to monitor the characteristic of interest (e.g., performance parameter) signal, and the operational environment characteristics for other changes. In this case, the method can loop back to step 704 to continue receiving sensor signal(s) as needed.

Following are some example implementations of the systems and methods described herein. While the following examples are described with respect to a residue performance, other characteristics of interest (e.g., other performance parameters) can also be used, such as for performance parameters other operations performed by the harvester.

In a first example, a machine enters a field with generally consistent crop yield, but gusty winds are generally moving laterally across the machine relative to the machine travel direction. In this example, the residue system parameters (e.g., operational parameters) are set, with the upwind side of the residue system attempting to compensate for the wind speeds near 15 mph by increasing their operational parameters, and the downwind side of the residue system attempting to not overthrow by reducing their operational parameters. The automation system can be engaged (e.g., automatically or by an operator), which can use residue performance as an input to make decisions on how well the residue system is performing and if an adjustment (e.g., operational parameter adjustment) is necessary. Using sensors and/or weather application (e.g., based on past wind conditions, or predictive wind), the wind is determined to be highly variable, with wind ranges of 5-15 mph changing frequently and inconsistently (e.g., changing values at inconsistent intervals, though frequently).

In these example conditions (e.g., operational environment conditions), if a prior or existing control system were in operation, the performance monitor system is monitoring the spread width (more specifically, the location of the spread relative to the cut edge width of the header). Normal sensitivity of the system would be such that a change in the performance parameter value (e.g., relative to some threshold value or some period of time) would result in an adjustment to the residue system. As such, with current/prior systems, during wind speeds of low values (e.g., around 5 mph) the material is being spread too far into the uncut crop as the system was initially set based on wind speeds near 15mph. Further, the current/prior system would adjust the residue system settings to change the spread to be less because of detected over-spreading. However, after the system adjusts, and during wind speeds of high values (e.g., near 15 mph) the spread is not travelling far enough, causing the system to then adjust again to increase residue system settings.

Using the systems and methods described herein, the system can determine the levels of the operational environment characteristic to be 5 mph min, 15 mph max, with a high level of variability. Using the systems and methods described herein, the system reviews the levels relative to the system limits (or expected levels): the minimum wind speed is below the operational parameter's maximum compensation factor of 20 mph; the maximum wind speed is below the operational parameter's maximum compensation factor of 20 mph; therefore the system determines that the environmental characteristics are within the operational range of the operational parameters, and the system could compensate for the values of the operational environment characteristic. However, because of the high level of variability of the wind, the sensitivity to adjust to changes in the performance parameter is modified such that the system is less reactive (i.e., reduce sensitivity). That is, the system can either change a threshold at which to react, change a time that the threshold has been exceeded (above or below) to react, or change an amount by which the threshold is exceeded (above or below). As such, the system does not respond as quickly or drastically to when a change occurs in the characteristic of interest (e.g., performance parameter) signal.

Continuing with this example, using the systems described herein, based on the levels of the operational environment characteristics and the limits (e.g., expected levels) determined, the automation system controller now has operational parameters determined that will result in performance that is mostly satisfactory and not creating new issues (e.g., over or under throw). For example, the system controller could do one of the following: 1—change the maximum limit of the spreader operational parameter to compensate for wind speeds of 10 mph rather than 15 mph, thus limiting the ‘overcompensation’ issue when wind speed drops closer to 5 mph; 2—change the time of threshold exceeded value such that if the material is being over-spread, the time to exceed is low (to be more responsive) and if the material is being under-spread, the time to exceed is high (to be less responsive or slower to respond); 3—change the threshold of the sensed value to react to, by increasing the threshold, thus making the system less reactive; and 4—change the amount by which the threshold must be exceeded.

In a second example, using similar type of steps described above in looking at the limits (or expected levels), the winds are variable at 25-40 mph. Because the system is only capable of compensation up to 20 mph, the variability of wind speeds between 25-40 mph is not accounted for because the system will still need to be at its maximum limits as the minimum weed speed (25 mph) is at or above the system compensation limits of 20 mph. As such, in this scenario, the example systems, described herein, can determine that the levels range of the operational environment characteristic is beyond the capability of the system, such that the limits of the operational parameters are adjusted to be maximum toward the upwind side and minimum to the downwind side. In these scenarios, where the range of the values of the input factors (e.g., operational environment characteristics) exceeds a level (or threshold), the system can respond by adjusting the limits of the operational parameters or by setting the operational parameters to their maximum.

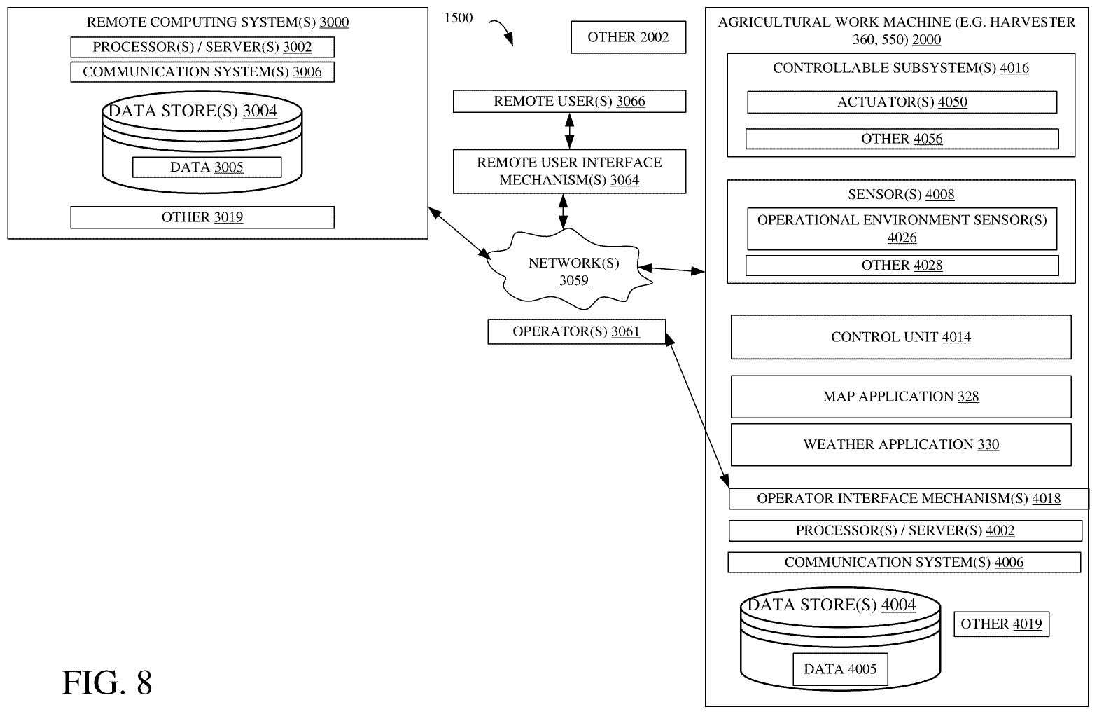

FIG. 8 is a block diagram showing an example of system 1500. System 1500 is, in one example, an example of system 300. System 1500 is, in one example, an example of system 500. System 1500 includes an agricultural work machine 2000 (e.g., harvester 360, 550). System 1500 also includes one or more remote computing systems 3000, one or more networks 3059, one or more remote user interface mechanisms 3064, and can include a variety of other items 2002 as well.

As shown in FIG. 8, work machine 2000, itself, illustratively includes one or more processors or servers 4002, one or more data stores 4004, one or more communication systems 4006, one or more sensors 4008, control unit 4014, map application 328, weather application 330, one or more controllable subsystems 4016, one or more operator interface mechanisms 4018, and can include various other items and functionality 4019 as well.

Remote computing systems 3000, as illustrated, include one or more processors or servers 3002, one or more data stores 3004, one or more communication systems 3006, and can include various other items and functionality 3019.

Data stores 3004 and data stores 4004 each store a variety of data (generally indicated data 3005 and data 4005 respectively), such as the various data described herein (e.g., inputs 350, sensor data, profile/parameters 334, levels 510, etc.). Additionally, data 3005 can include computer executable (readable) instructions that are executable by one or more processors or servers 3002 to implement other items or functionalities of system 100, including other items of remote computing systems 3000. Additionally, data 4005 can include computer executable (readable) instructions that are executable by one or more processors or servers 4002 to implement other items or functionalities of system 100, including other items or functionalities of harvester 306. The computer executable instructions in data stores 3004 and data stores 4004 can include instructions 336 or instructions 516. It will be understood that data stores 3004 and data stores 4004 can include different forms of data stores, for instance both volatile data stores (e.g., Random Access Memory (RAM)) and non-volatile data stores (e.g., Read Only Memory (ROM), hard drives, solid state drives, etc.). Further, it will be understood that data stores 3004 and data stores 4004 can include memory 304 or can include memory that stores information similar to the information stored in memory 304 as previously described and obtainable for use by other items of system 300 as previously described. Further, it will be understood that data stores 3004 and data stores 4004 can include memory 512 or can include memory that stores information similar to the information stored in memory 512 as previously described and obtainable for use by other items of system 502 as previously described.

Processor(s) or servers 3002 and processor(s) or servers 4002 can include processor 306 or can include processors similar to processor 306 and can be used to enable functionality similar to the functionality of processor 306 as previously described. Processor(s) or servers 3002 and processor(s) or servers 4002 can include processor 514 or can include processors similar to processor 514 and can be used to enable functionality similar to the functionality of processor 306 as previously described.

Sensors 4008 can include operational environment sensors 4026 and can include various other sensors 4028 as well. The sensor data (e.g., images, signals, etc.) generated by sensors 4008 can be communicated to remote computing systems 3000, and to other items of work machine 2000. Some examples of operational environment sensors 4026 have been previously described such as, but not limited to, feedrate sensors 308, crop moisture sensors 316, environmental sensors 322, as well as other sensors discussed elsewhere herein that detect operational environment characteristics. Other sensors 4028 can include sensors that detect performance parameters, such as, but not limited to, image sensors 402.

Control unit 4014 can, in one example, be (or be similar to) control unit 302 (previously described herein) and can, among other things (as previously described), generate control signals (e.g., action commands 352) to control one or more components of system 1500, such as one or more components of work machine 2000, such as controllable subsystems 4016 (e.g., to adjust operational parameters of the controllable subsystems 4016), interface mechanisms 4018, and communication system 4006. Control unit 4014 can, in one example, be (or be similar to) control system 502 (previously described herein) and can, among other things (as previously described), generate control signals (e.g., action commands) to control one or more components of system 1500, such as one or more components of work machine 200, such as controllable subsystems 4016 (e.g., to adjust operational parameters of the controllable subsystems 4016), interface mechanisms 4018, and communication system 4006.

Map application 328 and weather application 330 have been described elsewhere herein.

As shown, controllable subsystems 4016 include one or more actuators 4050 as well as various other items 4056. Actuators 4050 include a variety of different types of actuators. Actuators 4050 can include actuators that control the position (e.g., height, depth, or spacing) or orientation (e.g., pitch, roll, yaw, etc.) of components of work machine 2000 as well as actuators that control a speed of movement (e.g., speed of rotation, speed of reciprocation, etc.) of components of work machine 2000. Actuators 4050 can include, without limitation, motors, valves, pumps, hydraulic actuators (e.g., hydraulic cylinders, etc.), pneumatic actuators (e.g., pneumatic cylinders, etc.), electric actuators (e.g., linear actuators, etc.), as well as various other types of actuators. Some examples of actuators 4050 have been previously shown and described herein, such as actuators described in FIGS. 1 and 2 as well as other actuators described herein. Actuators 4050 are controllable to adjust operational parameters of various components of an agricultural work machine, such as harvester 360/550, such as the various operational parameters described elsewhere herein.

Communication systems 4006 are used to communicate between components of work machine 2000, or with other items of system 1500, such as remote computing systems 3000 or user interface mechanisms 3064, or a combination thereof. Communication systems 3006 are used to communicate between components of a remote computing system 3000 or with other items of system 1500, such as work machine 2000, other remote computing systems 3000, or user interface mechanisms 3064, or a combination thereof.

Communication systems 3006 and 4006 can both include one or more of wired communication circuitry and wireless communication circuitry, as well as wired and wireless communication components. In some examples, communication systems 3006 and 4006 can include one or more of a system for communicating over various networks, such as a communication system for communicating over the Internet, a cellular communication system, a system for communicating over a wide area network or a local area network, a system for communicating over a controller area network (CAN), such as a CAN bus, a system for communicating over a controller area network flexible data-rate (CAN-FD), such as a CAN-FD bus, a system for communication over a near field communication network, a system for communicating over ethernet, or a communication system configured to communicate over any of a variety of other networks. Communication systems 3006 and 4006 can both also include a system that facilitates downloads or transfers of information to and from a secure digital (SD) card or a universal serial bus (USB) card, or both. Communication systems 3006 and 4006 can both utilize network 3059. Networks 3059 can be any of a wide variety of different types of networks such as the Internet, a cellular network, a wide area network (WAN), a local area network (LAN), a controller area network (CAN), a controller area network flexible data-rate (CAN-FD), a near-field communication network, ethernet, or any of a wide variety of other networks.

FIG. 8 shows that one or more operators 3061 can operate work machine 2000. Operators 3061 interact with operator interface mechanisms, such as operator interface mechanism 4018. In some examples, operator interface mechanisms 4018 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, operators 3061 can interact with operator interface mechanisms 4018 using touch gestures. Additionally, at least some of the operator interface mechanisms 4018 can be used to present (e.g., display, audible presentation, haptic presentation, etc.) various information. One example of an operator interface mechanism 4018 is UI 332. The examples described above are provided as illustrative examples and are not intended to limit the scope of the present disclosure. Consequently, other types of operator interface mechanisms 4018 can be used and are within the scope of the present disclosure.

Additionally, in some examples, some operator interface mechanisms 4018 can be separate from (or separable from), but communicatively coupled to work machine 2000.

FIG. 8 also shows remote users 3066 interacting with work machine 2000, and remote computing systems 3000 through user interface mechanisms 3064 over networks 3059. In some examples, user interface mechanisms 3064 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the users 3066 can interact with user interface mechanisms 3064 using touch gestures. Additionally, at least some of the user interface mechanisms 3064 can be used to present (e.g., display, audible presentation, haptic presentation, etc.) various information. One example of a user interface mechanism 3064 is UI 332. The examples described above are provided as illustrative examples and are not intended to limit the scope of the present disclosure. Consequently, other types of user interface mechanisms 3064 can be used and are within the scope of the present disclosure.

Remote computing systems 3000 can be a wide variety of different types of systems, or combinations thereof. For example, remote computing systems 3000 can be in a remote server environment. Further, remote computing systems 3000 can be remote computing systems, such as mobile devices, a remote network, a farm manager system, a vendor system, or a wide variety of other remote systems. In one example, work machine 2000 can be controlled remotely by remote computing systems 3000 or by remote users 3066, or both. In some examples, operators 3061 are on-board (e.g., in an operator compartment, such as a cab) of work machine 2000. In some examples, operators 3061 are remote from the work machine 2000 and control the work machine 200 through one or more interface mechanisms (e.g., 4018) which are remote from the machine but operatively coupled (e.g., communicatively coupled, such as over networks 3059) to the machine (e.g., 2000).

As previously described, items in system 1500 can be distributed in various ways. For example, items in system 1500 can be distributed in various ways, including ways that differ from the example shown in FIG. 8. For example, but not by limitation, control unit 4014 (e.g., control unit 302 or control system 502), shown in FIG. 8 as being disposed on work machine 2000, can be located elsewhere, such as at one or more remote computing systems 3000. In yet other examples, control unit 4014 can be distributed across multiple items of system 1500, including for example, across a work machine 2000 and a remote computing system 3000. In yet other examples, each of the work machine 2000 and a remote computing system 3000 can include a respective control unit 4014. Further, other items of system 1500, such as map application 328 and weather application 330, can be distributed in various ways, including in ways similar to the ways in which control unit 4014 can be distributed.

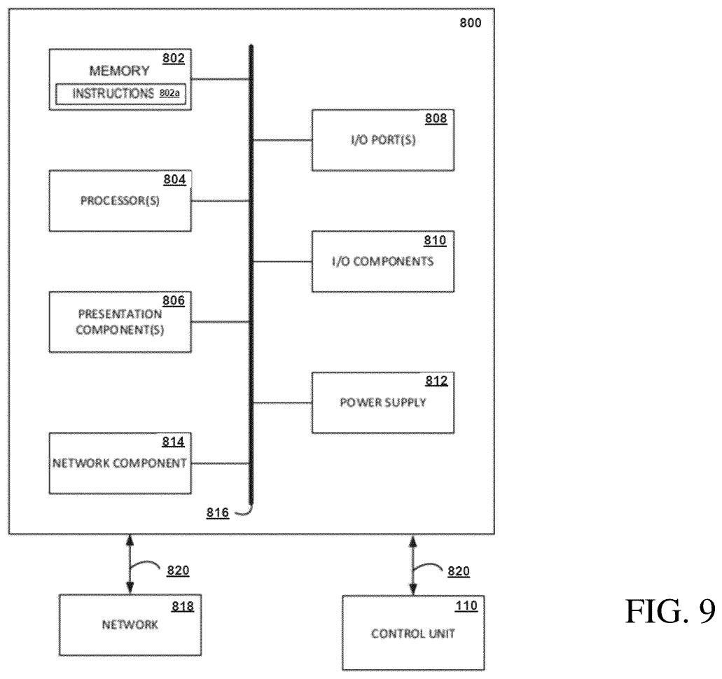

FIG. 9 is a schematic block diagram illustrating a block diagram of a computing device 800 suitable for implementing various aspects of the disclosure as described. For example, in operation, the computing device 800 is operable with the control unit 110 (e.g., such as control unit 302 of FIG. 3 or control system 502 of FIG. 5) to control operation of an agricultural work machine (e.g., harvester) or systems thereof (e.g., residue system) as described in more detail herein. FIG. 8 and the following discussion provide a brief, general description of a computing environment in/on which one or more or the implementations of one or more of the methods and/or system set forth herein may be implemented. The operating environment of FIG. 9 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, which perform particular tasks or implement particular abstract data types. Typically, the functionality of the computer readable instructions may be combined or distributed as desired in various environments.

In some examples, the computing device 800 includes a memory 802, one or more processors 804, and one or more presentation components 806. The disclosed examples associated with the computing device 800 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 8 and the references herein to a “computing device.” The disclosed examples are also practiced in distributed computing environments, where tasks are performed by remote-processing devices that are linked through a communications network. Further, while the computing device 800 is depicted as a single device, in one example, multiple computing devices work together and share the depicted device resources. For instance, in one example, the memory 802 is distributed across multiple devices, the processor(s) 804 provided are housed on different devices, and so on.

In one example, the memory 802 includes any of the computer-readable media discussed herein. In one example, the memory 802 is used to store and access instructions 502a configured to carry out the various operations disclosed herein. In some examples, the memory 802 includes computer storage media in the form of volatile and/or nonvolatile memory, removable or non-removable memory, data disks in virtual environments, or a combination thereof. In one example, the processor(s) 804 includes any quantity of processing units that read data from various entities, such as the memory 802 or input/output (I/O) components 810. Specifically, the processor(s) 804 are programmed to execute computer-executable instructions for implementing aspects of the disclosure. In one example, the instructions 802a are performed by the processor 804, by multiple processors within the computing device 800, or by a processor external to the computing device 800. In some examples, the processor(s) 804 are programmed to execute instructions such as those illustrated in the flow charts discussed herein and depicted in the accompanying drawings.

In other implementations, the computing device 800 may include additional features and/or functionality. For example, the computing device 800 may also include additional storage (e.g., removable and/or non-removable) including, but not limited to, magnetic storage, optical storage, and the like. Such additional storage is illustrated in FIG. 9 by the memory 802. In one implementation, computer readable instructions to implement one or more implementations provided herein may be in the memory 802 as described herein. The memory 802 may also store other computer readable instructions to implement an operating system, an application program and the like. Computer readable instructions may be loaded in the memory 802 for execution by the processor(s) 804, for example.

The presentation component(s) 806 present data indications to an operator or to another device. In one example, the presentation components 806 include a display device, speaker, printing component, vibrating component, etc. One skilled in the art will understand and appreciate that computer data is presented in a number of ways, such as visually in a graphical user interface (GUI), audibly through speakers, wirelessly between the computing device 800, across a wired connection, or in other ways. In one example, the presentation component(s) 806 are not used when processes and operations are automated that a need for human interaction is lessened or not needed. I/O ports 808 allow the computing device 800 to be logically coupled to other devices including the I/O components 810, some of which is built in. Implementations of the I/O components 810 include, for example but without limitation, a microphone, keyboard, mouse, joystick, pen, game pad, satellite dish, scanner, printer, wireless device, camera, etc.

The computing device 800 includes a bus 816 that directly or indirectly couples the following devices: the memory 802, the one or more processors 804, the one or more presentation components 806, the input/output (I/O) ports 808, the I/O components 810, a power supply 812, and a network component 814. The computing device 800 should not be interpreted as having any dependency or requirement related to any single component or combination of components illustrated therein. The bus 816 represents one or more busses (such as an address bus, data bus, or a combination thereof). Although the various blocks of FIG. 9 are shown with lines for the sake of clarity, some implementations blur functionality over various different components described herein.

The components of the computing device 800 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 800 may be interconnected by a network. For example, the memory 802 may be comprised of multiple physical memory units located in different physical locations interconnected by a network.

In some examples, the computing device 800 is communicatively coupled to a network 818 using the network component 814. In some examples, the network component 814 includes a network interface card and/or computer-executable instructions (e.g., a driver) for operating the network interface card. In one example, communication between the computing device 800 and other devices occurs using any protocol or mechanism over a wired or wireless connection 820. In some examples, the network component 814 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 820 may include, but is not limited to, a modem, a Network Interface Card (NIC), an integrated network interface, a radio frequency transmitter/receiver, an infrared port, a USB connection or other interfaces for connecting the computing device 800 to other computing devices. The connection 820 may transmit and/or receive communication media.

Although described in connection with the computing device 800, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms can include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition can be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores can be local to the systems accessing the data stores, one or more of the data stores can all be located remote form a system utilizing the data store, or one or more data stores can be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality can be distributed among more components. In different examples, some functionality can be added, and some can be removed.

It will be noted that the above discussion has described a variety of different systems, units, applications components, and interactions. It will be appreciated that any or all of such systems, units, applications, components, and interactions can be implemented by hardware items, such as one or more processors, one or more processors executing computer executable instructions stored in memory, memory, or other processing components, some of which are described elsewhere herein, that perform the functions associated with those systems, units, applications, components, and interactions. In addition, any or all of the systems, units, applications, components, and interactions can be implemented by software that is loaded into a memory and is subsequently executed by one or more processors or one or more servers or other computing component(s), as described elsewhere herein. Any or all of the systems, units, applications, components, and interactions can also be implemented by different combinations of hardware, software, firmware, etc., some examples of which are described elsewhere herein. These are some examples of different structures that can be used to implement any or all of the systems, units, applications, components, and interactions described above. Other structures can be used as well.

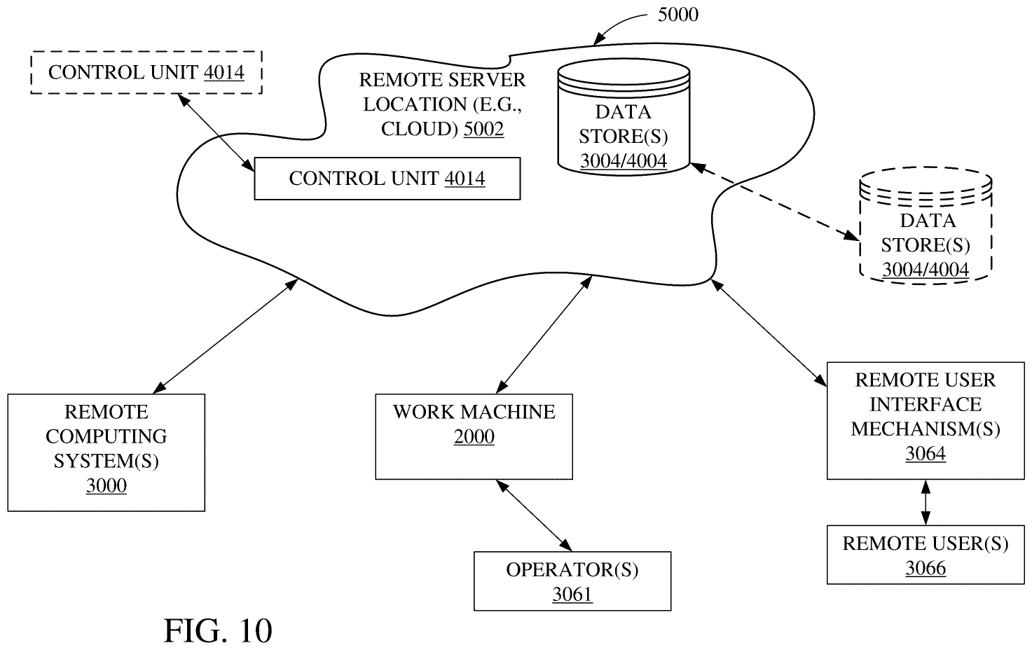

FIG. 10 is a block diagram of a remote server architecture 5000. FIG. 10, also shows work machine 2000, one or more remote computing systems 3000, and one or more remote user interface mechanisms 3064 in communication with the remote server environment. The work machine 2000, remote computing systems 3000, and remote user interface mechanisms 3064 communicate with elements in a remote server architecture 5000. In some examples, remote server architecture 5000 provides computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and can be accessible through a web browser or any other computing component. Software or components shown in previous figures as well as data associated therewith, can be stored on servers at a remote location. The computing resources in a remote server environment can be consolidated at a remote data center location, or the computing resources can be dispersed to a plurality of remote data centers. Remote server infrastructures can deliver services through shared data centers, even though the services appear as a single point of access for the user. Thus, the components and functions described herein can be provided from a remote server at a remote location using a remote server architecture. Alternatively, the components and functions can be provided from a server, or the components and functions can be installed on client devices directly, or in other ways.

In the example shown in FIG. 10, some items are similar to those shown in previous figures and those items are similarly numbered. FIG. 10 specifically shows that control unit 4014, data stores 3004, or data stores 4004, or a combination thereof, can be located at a server location 5002 that is remote from the work machine 2000, remote computing systems 3000, and remote user interface mechanisms 3064. Therefore, in the example shown in FIG. 10, work machine 2000, remote computing systems 3000, and remote user interface mechanisms 3064 access systems through remote server location 5002. In other examples, various other items can also be located at server location 5002, such as various other items of system 1500.

FIG. 10 also depicts another example of a remote server architecture. FIG. 10 shows that some elements of previous figures can be disposed at a remote server location 5002 while others can be located elsewhere. By way of example, one or more of data store(s) 3004 and 4004 can be disposed at a location separate from location 5002 and accessed via the remote server at location 5002. Similarly, control unit 4014 can be disposed at a location separate from location 5002 and accessed via the remote server at location 5002. Regardless of where the elements are located, the elements can be accessed directly by work machine 2000, remote computing systems 3000, and remote user interface mechanisms 3064 through a network such as a wide area network or a local area network; the elements can be hosted at a remote site by a service; or the elements can be provided as a service or accessed by a connection service that resides in a remote location. Also, data can be stored in any location, and the stored data can be accessed by, or forwarded to, operators, users, or systems. For instance, physical carriers can be used instead of, or in addition to, electromagnetic wave carriers. In some examples, where wireless telecommunication service coverage is poor or nonexistent, another machine, such as a fuel truck or other mobile machine or vehicle, can have an automated, semi-automated or manual information collection system. As a mobile machine (e.g., 2000) comes close to the machine containing the information collection system, such as a fuel truck prior to fueling, or other mobile machine or vehicle, the information collection system collects the information from the mobile machine (e.g., 2000) using any type of ad-hoc wireless connection. The collected information can then be forwarded to another network when the machine containing the received information reaches a location where wireless telecommunication service coverage or other wireless coverage is available. For instance, a fuel truck, can enter an area having wireless communication coverage when traveling to a location to fuel other machines or when at a main fuel storage location. Other mobile machines or vehicles can enter an area having wireless communication coverage when traveling to other locations or when at another location. All of these architectures are contemplated herein. Further, the information can be stored on a mobile machine (e.g., 2000) until the mobile machine enters an area having wireless communication coverage. The mobile machine (e.g., 2000), itself, can send the information to another network.

It will also be noted that the elements of previous figures, or portions thereof, can be disposed on a wide variety of different devices. One or more of those devices can include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 5000 can include cybersecurity measures. Without limitation, these measures can include encryption of data on storage devices, encryption of data sent between network nodes, authentication of people or processes accessing data, as well as the use of ledgers for recording metadata, data, data transfers, data accesses, and data transformations. In some examples, the ledgers can be distributed and immutable (e.g., implemented as blockchain).

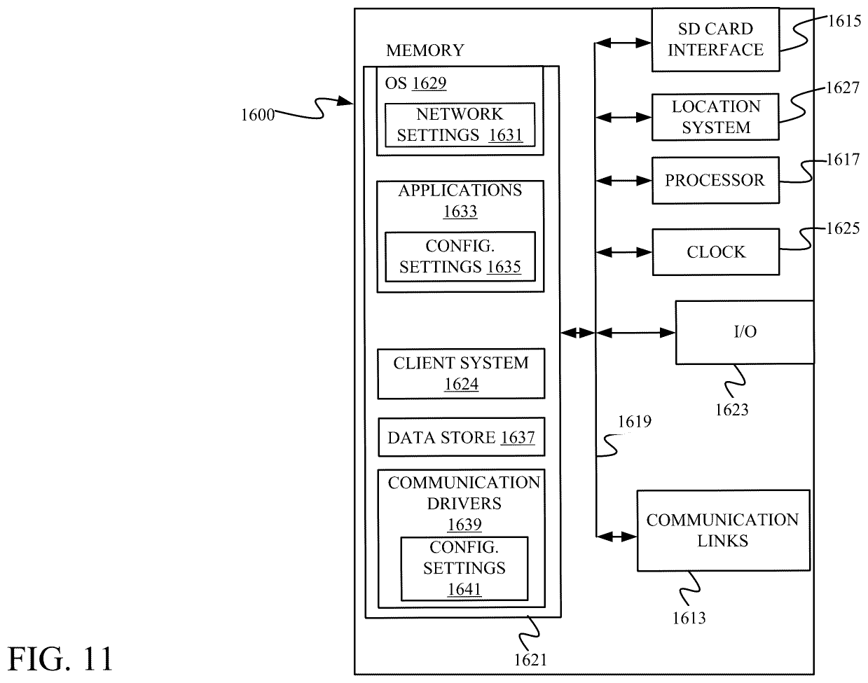

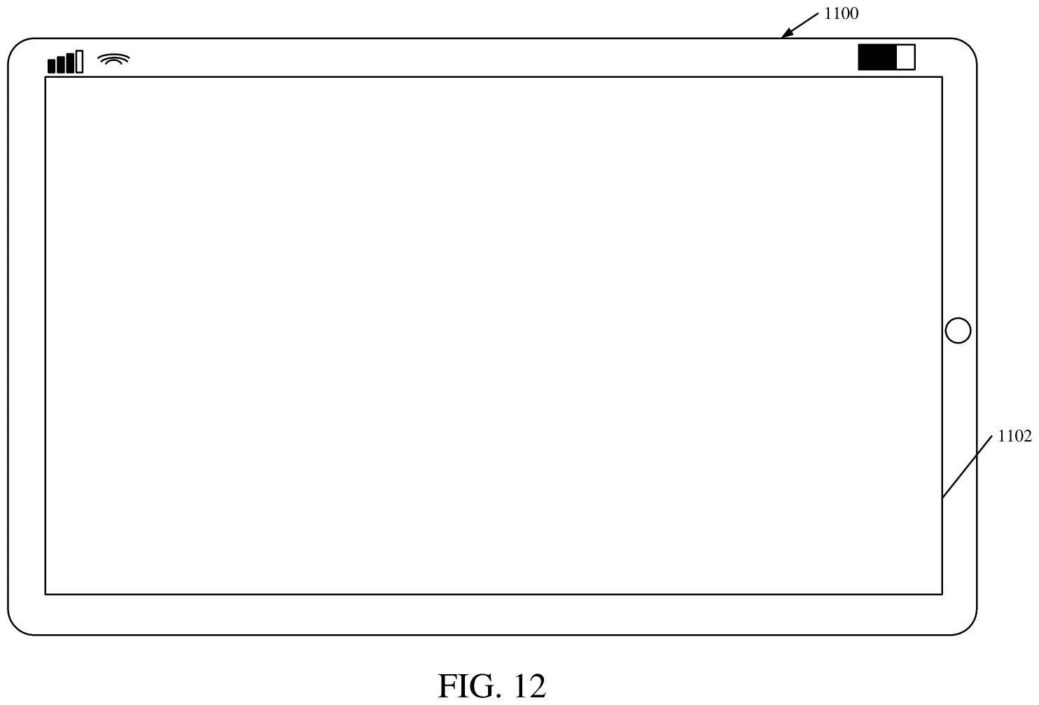

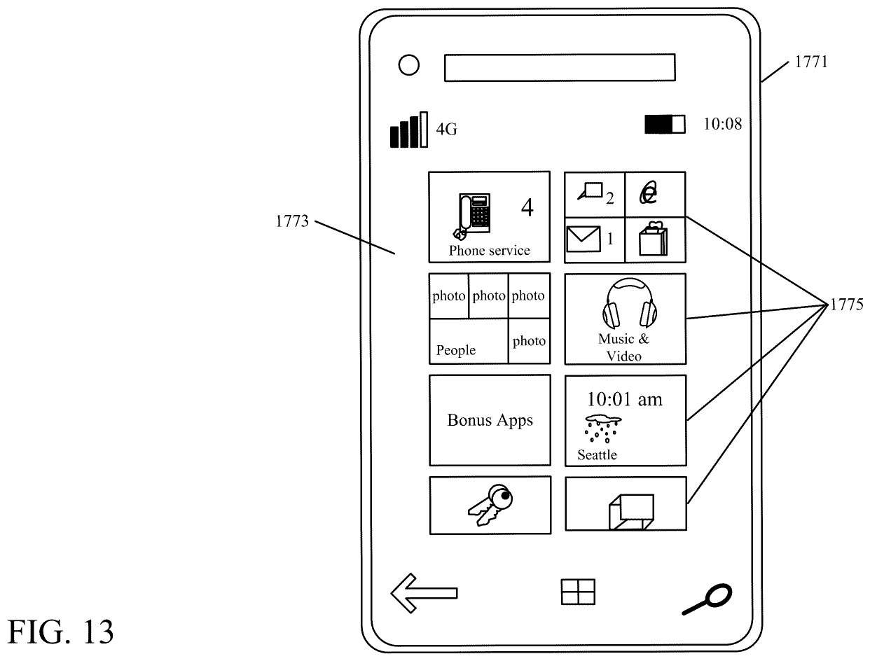

FIG. 11 is a simplified block diagram of one illustrative example of a handheld or mobile computing device that can be used as a user's or client's handheld device 1600, in which the present system (or parts of it) can be deployed. For instance, a mobile device can be deployed in the operator compartment of a mobile machine (e.g., 2000) or can be communicably coupled to a mobile machine (e.g., 2000) for use in generating, processing, or displaying the information and outputs discussed above. FIGS. 12 and 13 are examples of handheld or mobile devices.

FIG. 11 provides a general block diagram of the components of a client device 1600 that can run some components shown in previous figures, that interacts with them, or both. In the device 1600, a communications link 1613 is provided that allows the handheld device to communicate with other computing devices and under some examples provides a channel for receiving information automatically, such as by scanning. Examples of communications link 1613 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1615. Interface 1615 and communication links 1613 communicate with a processor 1617 (which can also embody processors or servers from other figures) along a bus 1619 that is also connected to memory 1621 and input/output (I/O) components 1623, as well as clock 1625 and location system 1627.

I/O components 1623, in one example, are provided to facilitate input and output operations. I/O components 1623 for various examples of the device 1600 can include input components such as buttons, touch sensors, optical sensors, microphones, touch screens, proximity sensors, accelerometers, orientation sensors and output components such as a display device, a speaker, and or a printer port. Other I/O components 1623 can be used as well.

Clock 1625 illustratively comprises a real time clock component that outputs a time and date. It can also, illustratively, provide timing functions for processor 1617. Location system 1627 illustratively includes a component that outputs a current geographical location of device 1600. This can include, for instance, a global positioning system (GPS) receiver, a LORAN system, a dead reckoning system, a cellular triangulation system, or other positioning system. Location system 1627 can also include, for example, mapping software or navigation software that generates desired maps, navigation routes and other geographic functions.

Memory 1621 stores operating system 1629, network settings 1631, applications 1633, application configuration settings 1635, client system 1624, data store 1637, communication drivers 1639, and communication configuration settings 1641. Memory 1621 can include all types of tangible volatile and non-volatile computer-readable memory devices. Memory 1621 can also include computer storage media (described below). Memory 1621 stores computer readable instructions that, when executed by processor 1617, cause the processor to perform computer-implemented steps or functions according to the instructions. Processor 1617 can be activated by other components to facilitate their functionality as well.

FIG. 12 shows one example in which device 1600 is a tablet computer 1100. In FIG. 12, computer 1100 is shown with user interface display screen 1102. Screen 1102 can be a touch screen or a pen-enabled interface that receives inputs from a pen or stylus. Tablet computer 1100 can also use an on-screen virtual keyboard. Of course, computer 1100 can also be attached to a keyboard or other user input device through a suitable attachment mechanism, such as a wireless link or USB port, for instance. Computer 1100 can also illustratively receive voice inputs as well.

FIG. 13 is similar to FIG. 12 except that the device is a smart phone 1771. Smart phone 1771 has a touch sensitive display 1773 that displays icons or tiles or other user input mechanisms 1775. Mechanisms 1775 can be used by a user to run applications, make calls, perform data transfer operations, etc. In general, smart phone 1771 is built on a mobile operating system and offers more advanced computing capability and connectivity than a feature phone.

Note that other forms of the devices 1600 are possible.

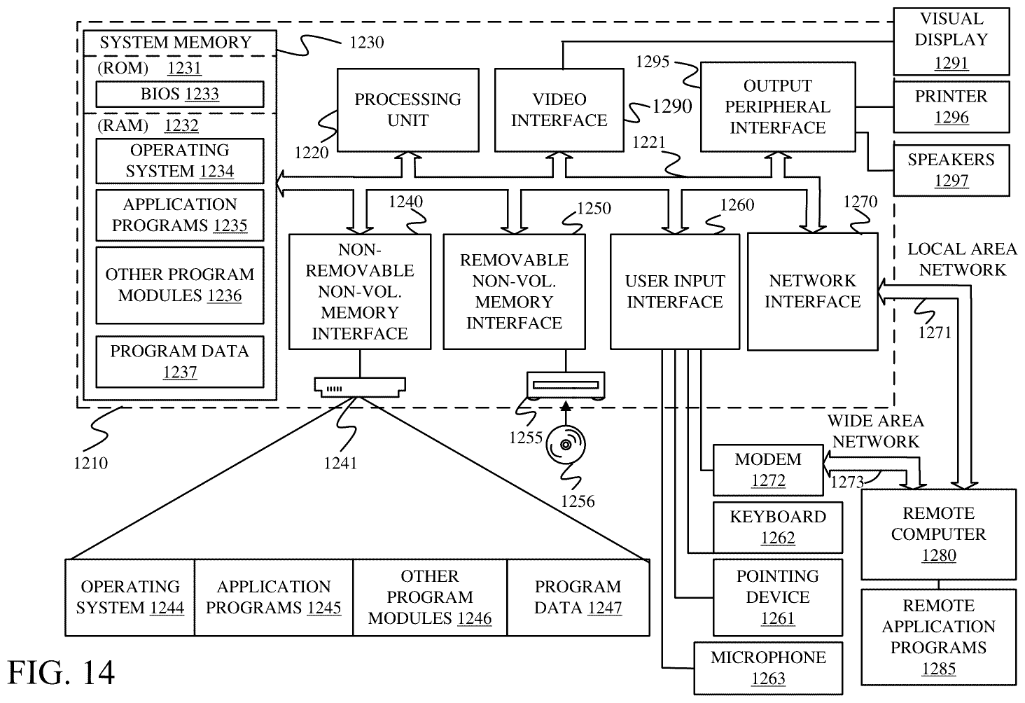

FIG. 14 is one example of a computing environment in which elements of previous figures described herein can be deployed. With reference to FIG. 14, an example system for implementing some embodiments includes a computing device in the form of a computer 1210 programmed to operate as discussed above. Components of computer 1210 can include, but are not limited to, a processing unit 1220 (which can comprise processors or servers from previous figures), a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures. Memory and programs described with respect to previous figures described herein can be deployed in corresponding portions of FIG. 14.

Computer 1210 typically includes a variety of computer readable media. Computer readable media can be any available media that can be accessed by computer 1210 and includes both volatile and nonvolatile media, removable and non-removable media. By way of example, and not limitation, computer readable media can comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 14 illustrates operating system 1234, application programs 1235, other program modules 1236, and program data 1237.

The computer 1210 can also include other removable/non-removable volatile/nonvolatile computer storage media. By way of example only, FIG. 14 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 14 provide storage of computer readable instructions, data structures, program modules and other data for the computer 1210. In FIG. 14, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user can enter commands and information into the computer 1210 through input devices such as a keyboard 1262, a microphone 1263, and a pointing device 1261, such as a mouse, trackball or touch pad. Other input devices (not shown) can include a joystick, game pad, satellite dish, scanner, or the like. These and other input devices are often connected to the processing unit 1220 through a user input interface 1260 that is coupled to the system bus, but can be connected by other interface and bus structures. A visual display 1291 or other type of display device is also connected to the system bus 1221 via an interface, such as a video interface 1290. In addition to the monitor, computers can also include other peripheral output devices such as speakers 1297 and printer 1296, which can be connected through an output peripheral interface 1295.

The computer 1210 is operated in a networked environment using logical connections (such as a controller area network-CAN, local area network-LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules can be stored in a remote memory storage device. FIG. 14 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this disclosure. It is intended to include all such modifications and alterations in so far as they come within the scope of the appended claims or the equivalents thereof.

What is claimed is:

1. An agricultural system comprising:
one or more processors; and
memory storing instructions, executable by the one or more processors, that, when executed by the one or more processors, configure the agricultural system to:
monitor a performance parameter of an agricultural work machine at a worksite;
monitor one or more operational environment conditions relative to the worksite;
determine a sensitivity with which to control the agricultural work machine based, at least, on the one or more operational environment conditions; and
control the agricultural work machine based, at least, on the sensitivity.

2. The agricultural system of claim 1, wherein the performance parameter comprises residue performance, wherein the agricultural work machine comprises a harvester, and wherein the one or more operational environment conditions comprise: (i) a travel speed of the harvester at the worksite; (ii) a heading of the harvester at the worksite; (iii) a feedrate of the harvester at the worksite; (iv) a plant moisture of plants at the worksite; (v) a weather condition of the worksite; (vi) a terrain condition of the worksite; (vii) a height of a header of the harvester at the worksite; or a combination of (i), (ii), (iii), (iv), (v), (vi), and (vii).

3. The agricultural system of claim 2, wherein instructions, when executed by the one or more processors, configure the agricultural system to control the harvester by controlling one or more actuators to control one or more operational parameters of a residue system of the harvester based, at least, on the sensitivity and the residue performance.

4. The agricultural system of claim 1, wherein the instructions, when executed by the one or more processors, further configure the agricultural system to:
determine one or more values of each operational environment condition of the one or more operational environment conditions;
compare the one or more values of each operational environment condition to a respective reference operational environment condition value; and
determine the sensitivity based, at least, on the comparison of the one or more values of each operational environment condition to the respective reference operational environment condition value.

5. The agricultural system of claim 1, wherein the instructions, when executed by the one or more processors, further configure the agricultural system to:
determine one or more values of each operational environment condition of the one or more operational environment conditions;
determine a variability level of each operational environment condition of the one or more operational environment conditions based on the one or more values of each operational environment condition of the one or more operational environment conditions; and
determine the sensitivity based, at least, on the variability level of each operational environment condition of the one or more operational environment conditions.

6. The agricultural system of claim 1, wherein the instructions, when executed by the one or more processors, further configure the agricultural system to:
determine one or more values of each operational environment condition of the one or more operational environment conditions;
determine the sensitivity by: (i) determining a variability level of each operational environment of the one or more operational environment conditions based on the one or more values of each operational environment condition; (ii) comparing the one or more values of each the operational environment condition to a respective reference operational environment condition; or (iii) (i) and (ii).

7. The agricultural system of claim 1, wherein the sensitivity defines an amount of time for which the performance parameter has to exceed a threshold performance parameter and wherein the instructions, when executed by the one or more processors, further configure the agricultural system to:
determine one or more values of the performance parameter;
based on the determined one or more values of the performance parameter, determine that the performance parameter has exceeded the threshold performance parameter for the amount of time defined by the sensitivity; and
control the agricultural work machine based, at least, on the determination that the performance parameter has exceeded the threshold performance parameter for the amount of time defined by the sensitivity.

8. The agricultural system of claim 1, wherein the sensitivity defines an amount by which the performance parameter has to exceed a threshold performance parameter and wherein the instructions, when executed by the one or more processors, further configure the agricultural system to:
determine one or more values of the performance parameter;
based on the determined one or more values of the performance parameter, determine that the performance parameter exceeds the threshold performance parameter by, at least, the amount defined by the sensitivity; and
control the agricultural work machine based, at least, on the determination that the performance parameter exceeds the threshold performance parameter by, at least, the amount defined by the sensitivity.

9. The agricultural system of claim 1, wherein the sensitivity defines a threshold performance parameter value or value range and wherein the instructions, when executed by the one or more processors, further configure the agricultural system to:
determine one or more values of the performance parameter;
compare the one or more values of the performance parameter to the threshold performance parameter value or value range defined by the sensitivity; and
control the agricultural work machine based, at least, on the comparison of the one or more values of the performance parameter to the threshold performance parameter value or value range defined by the sensitivity.

10. The agricultural system of claim 1, wherein the sensitivity defines a limit of an operational parameter of the agricultural work machine, and wherein the instructions, when executed by the one or more processors, further configure the agricultural system to:
control the agricultural work machine, to adjust the operational parameter to the limit defined by the sensitivity.

11. A computer implemented method comprising:
monitoring a performance parameter of an agricultural work machine at a worksite;
monitoring one or more operational environment conditions relative to the worksite;
determining a sensitivity with which to control the agricultural work machine based, at least, on the one or more operational environment conditions; and
controlling the agricultural work machine based, at least, on the sensitivity.

12. The computer implemented method of claim 11 and further comprising:
determining one or more values of each operational environment condition of the one or more operational environment conditions;
comparing the one or more values of each operational environment condition to a respective reference operational environment condition value; and
determine the sensitivity based, at least, on the comparison of the one or more values of each operational environment condition to the respective reference operational environment condition.

13. The computer implemented method of claim 11 and further comprising:
determining one or more values of each operational environment condition of the one or more operational environment conditions;
determining a variability level of each operational environment condition of the one or more operational environment conditions based on the one or more values of each operational environment condition of the one or more operational environment conditions; and
determining the sensitivity based, at least, on the variability level of each operational environment condition of the one or more operational environment conditions.

14. The computer implemented method of claim 11 and further comprising:
determining one or more values of each operational environment condition of the one or more operational environment conditions;
determining the sensitivity by: (i) determining a variability level of each operational environment of the one or more operational environment conditions based on the one or more values of each operational environment condition; (ii) comparing the one or more values of each the operational environment condition to a respective reference operational environment condition; or (iii) (i) and (ii).

15. The computer implemented method of claim 11, wherein the sensitivity defines an amount of time for which the performance parameter has to exceed a threshold performance parameter, the computer implemented method further comprising:
determining one or more values of the performance parameter;
determining, based on the determined one or more values of the performance parameter, that the performance parameter has exceeded the threshold performance parameter for the amount of time defined by the sensitivity; and
controlling the agricultural work machine based, at least, on the determination that the performance parameter has exceeded the threshold performance parameter for the amount of time defined by the sensitivity.

16. The computer implemented method of claim 11, wherein the sensitivity defines an amount by which the performance parameter has to exceed a threshold performance parameter, the computer implemented method further comprising:
determining one or more values of the performance parameter;
determining, based on the determined one or more values of the performance parameter, that the performance parameter exceeds the threshold performance parameter by, at least, the amount defined by the sensitivity; and
controlling the agricultural work machine based, at least, on the determination that the performance parameter exceeds the threshold performance parameter by, at least, the amount defined by the sensitivity.

17. The computer implemented method of claim 11, wherein the sensitivity defines a threshold performance parameter value or value range, the computer implemented method further comprising:
determining one or more values of the performance parameter;
comparing the one or more values of the performance parameter to the threshold performance parameter value or value range defined by the sensitivity; and
controlling the agricultural work machine based, at least, on the comparison of the one or more values of the performance parameter to the threshold performance parameter value or value range defined by the sensitivity.

18. The computer implemented method of claim 11, wherein the sensitivity defines a limit of an operational parameter of the agricultural work machine, the computer implemented method further comprising:
controlling the agricultural work machine, to adjust the operational parameter to the limit defined by the sensitivity.

19. An agricultural work machine comprising:
one or more processors; and
memory storing instructions executable by the one or more processors that, when executed by the one or more processors, configure the agricultural work machine to:
monitor a performance parameter of the agricultural work machine at a worksite;
monitor one or more operational environment conditions relative to the worksite;
generate a sensitivity with which to control the agricultural work machine based, at least, on the one or more operational environment conditions; and
control the agricultural work machine based, at least, on the sensitivity.

20. The agricultural work machine of claim 19, wherein the sensitivity defines at least one of: (i) an amount by which the performance parameter has to exceed a threshold performance parameter; (ii) an amount of time for which the performance parameter has to exceed a threshold performance parameter; (iii) a threshold performance parameter; or (iv) an operational parameter limit.
